(19) United States
(12) Patent Application Publication
(10) Pub. No.: US 2022/0164811 A1
(43) Pub. Date: May 26, 2022

(54) System and Method for Small Cohort Data Collection, Missing Information Detection, Contradictions Resolution, and Trusted Information Extraction

(71) Applicant: Michael Pindrik, Baltimore, MD (US)

(72) Inventor: Michael Pindrik, Baltimore, MD (US)

(21) Appl. No.: 17/102,866

(22) Filed: Nov. 24, 2020

(51) Int. Cl. G06Q 30/02; G06F 16/953

(52) U.S. Cl. CPC G06Q 30/0203; G06F 16/953

(57) ABSTRACT

A system and method are provided for small cohort data collection, missing information detection, contradictions resolution, and trusted information extraction. The system of the present invention includes a remote server that is used to manage at least one leader account and a plurality of participant accounts. A plurality of nearby accounts from the plurality of participant accounts is geofenced around the leader account. The user with the leader account can post a questionnaire. The plurality of nearby accounts can respond to the questionnaire posted by the leader account. The remote server collects and analyzes the responses from the plurality of nearby accounts by comparing the responses to reference information. If there is any missing information and/or contradictions within the responses, the remote server executes an interrogation process in order to resolve the missing information and/or contradictions within the responses.

### FIELD OF THE INVENTION

The present invention relates generally to data collection and analysis. More specifically, the present invention is a system and method for small cohort data collection, missing information detection, contradictions resolution, and trusted information extraction.

### BACKGROUND OF THE INVENTION

Data collection and analysis is common in various applications. These actions can be tedious for a human, so it is being improved by using computing systems. However, computing systems may not be able to collect and provide trusted information. In more detail, computing systems may not be able to identify if there is missing information and/or contradictions within the collected information. Thus, an individual or organization utilizing computing systems for data collection and analysis may not receive trusted information.

It is therefore an objective of the present invention to provide a system and method for small cohort data collection, missing information detection, contradictions resolution, and trusted information extraction. The system includes a backend database computing system managed by a remote server. The remote server allows a user with a leader account to post questionnaires for various applications such as, but not limited to, ordering food or resolving in incident. Users with participant accounts can respond to the questionnaire if they are physically nearby the user with the leader account. The remote server collects the responses and then analyzes the responses in order to identify missing information and/or contradictions within the responses. The remote server then interrogates users in order to resolve the missing information and/or eliminate contradictions within the responses. The resolved responses are then delivered to the user with the leader account, and thus, the user with the leader account receives trusted information.

### BRIEF DESCRIPTION OF THE DRAWINGS

FIG. 1 is a block diagram illustrating the system of the present invention.

FIG. 2A is a flowchart illustrating the overall process for the method of the present invention.

FIG. 2B is a continuation of FIG. 2A.

FIG. 3 is a flowchart illustrating the subprocess of utilizing the plurality of potential responses as the reference information.

FIG. 4 is a flowchart illustrating the subprocess of utilizing a plurality of current responses from multiple nearby accounts as the reference information.

FIG. 5 is a flowchart illustrating the subprocess of converting and analyzing the response in a tuple form.

FIG. 6 is a flowchart detailing the interrogation process from FIG. 2B.

FIG. 7 is a flowchart illustrating the subprocess of providing options for corrective information to the arbitrary account.

FIG. 8 is flowchart illustrating the subprocess on how the nearby accounts are geofenced around the leader account.

FIG. 9 is a flowchart illustrating the subprocess of generating and merging databases of multiple accounts in order to eliminate contradictions.

FIG. 10 is flowchart detailing the interrogation process from FIG. 9.

FIG. 11 is a block diagram illustrating the system of the present invention with the GPS modules of the leader PC device and the participant PC devices.

### DETAIL DESCRIPTIONS OF THE INVENTION

All illustrations of the drawings are for the purpose of describing selected versions of the present invention and are not intended to limit the scope of the present invention.

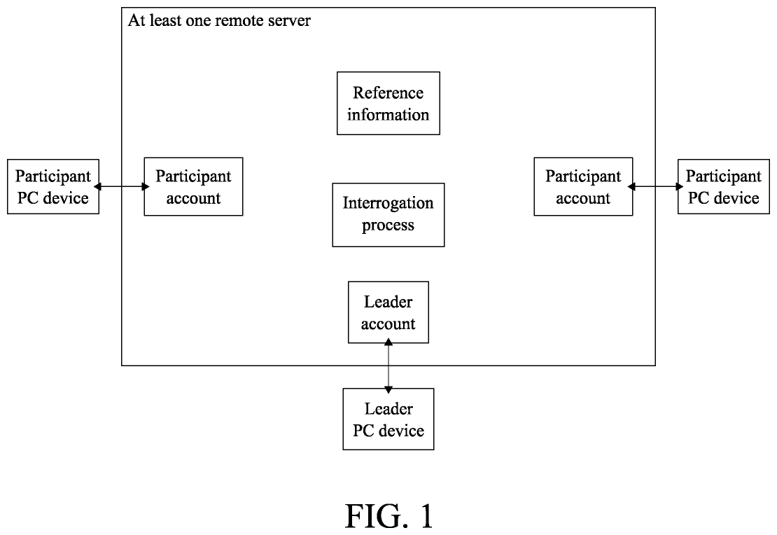

In reference to FIGS. 1 through 11, the present invention is a system and method for small cohort data collection, missing information detection, contradictions resolution, and trusted information extraction. With reference to FIG. 1, the system of the present invention includes at least one remote server that manages at least one leader account (Step A). The leader account is associated with a corresponding leader personal computing (PC) device. The remote server is preferably a backend database server capable of executing multiple processes and storing information. The leader account may belong to any user or organization that requires information for various situations. The corresponding leader PC device may be any computing device such as, but not limited to, a desktop computer, a mobile device, or a notebook computer. The remote server is also used to manage a plurality of participant accounts (Step B). Each participant account is associated with a corresponding participant PC device, and a plurality of nearby accounts from the plurality of participant accounts is geofenced around the leader account. Each participant account belongs to a user that wants to interact with the user or organization associated to the leader account. Similar to the leader PC device, the corresponding participant PC device may be any computing device such as, but not limited to, a desktop computer, a mobile device, or a notebook computer. Additionally, each of the plurality of nearby accounts belong to a user that is physically located near the user or organization associated to the leader account. The present invention may be used in various applications such as, but not limited to, the field of artificial intelligence or online multiplayer video games.

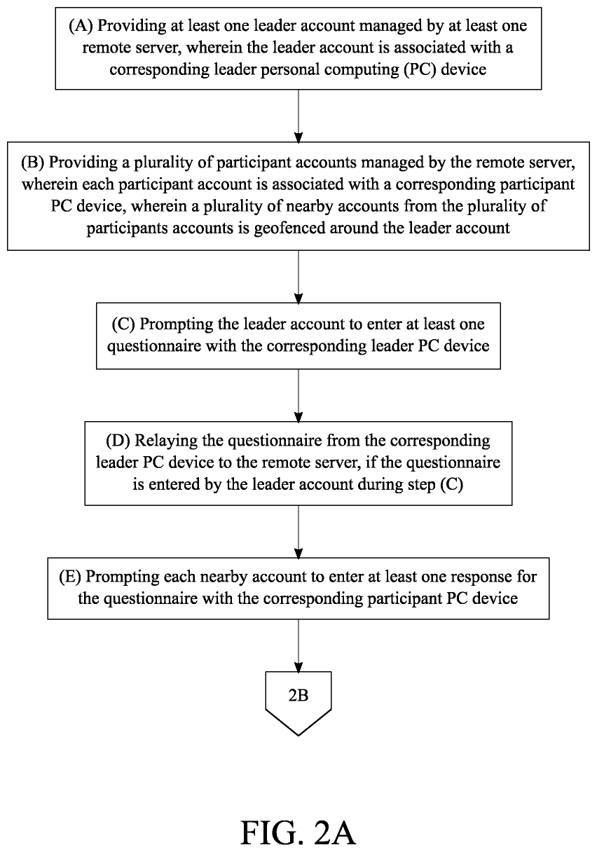

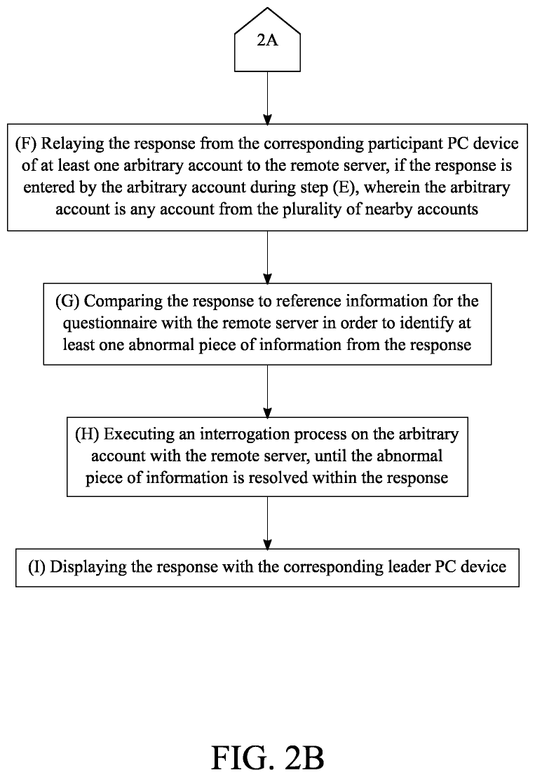

The method of the present invention follows an overall process that allows for small cohort data collection, missing information detection, contradictions resolution, and trusted information extraction. With reference to FIG. 2A, the leader account is prompted to enter at least one questionnaire with the corresponding leader PC device (Step C). The questionnaire may be a list of questions related to actions such as, but not limited, ordering food from a restaurant or resolving an incident. The questionnaire is relayed from the corresponding leader PC device to the remote server, if the questionnaire is entered by the leader account during Step C (Step D). Thus, the remote server can store and process the questionnaire. Next, each nearby account is prompted to enter at least one response for the questionnaire with the corresponding participant PC device (Step E). The response is a set of answers to the list of questions provided by the questionnaire. With reference to FIG. 2B, the response is relayed from the corresponding participant PC device of at least one arbitrary account to the remote sever, if the response is entered by the arbitrary account during Step E (Step F). The arbitrary account is any account from the plurality of nearby accounts. Thus, the remote server can store and analyze the response. The remote server then compares the response to reference information for the questionnaire with the remote server in order to identify at least one abnormal piece of information from the response (Step G). The reference information is a set of data that is related to the questionnaire and includes possible answers that can be in a response from the arbitrary account. The abnormal piece of information may be contradictory or missing information in the response from the arbitrary account. The remote server executes an interrogation process on the arbitrary account, until the abnormal piece of information is resolved within the response (Step H). The interrogation process is a process that collects more information from the arbitrary account. Finally, the response, with all contradictions and/or missing information resolved, is displayed with the corresponding leader PC device (Step I). Thus, the user or organization associated with the leader account has access to a trusted response provided by the arbitrary account.

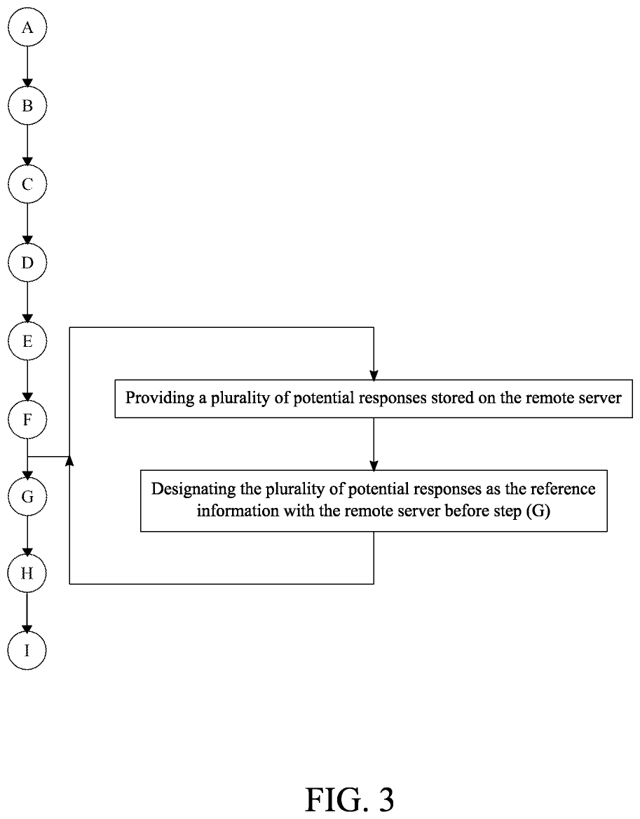

In order for the remote server to utilize a plurality of potential responses as the reference information and with reference to FIG. 3, the following subprocess is executed. A plurality of potential responses stored on the remote server. The plurality of potential responses is a set of typical answers that are related to the questionnaire. For example, the plurality of potential responses can be answers that were previously given to the questionnaire or can be answers that were expected to be given by a creator of the questionnaire. The remote server designates the plurality of potential responses as the reference information before Step G. Thus, the remote server utilizes the plurality of potential responses as the reference information.

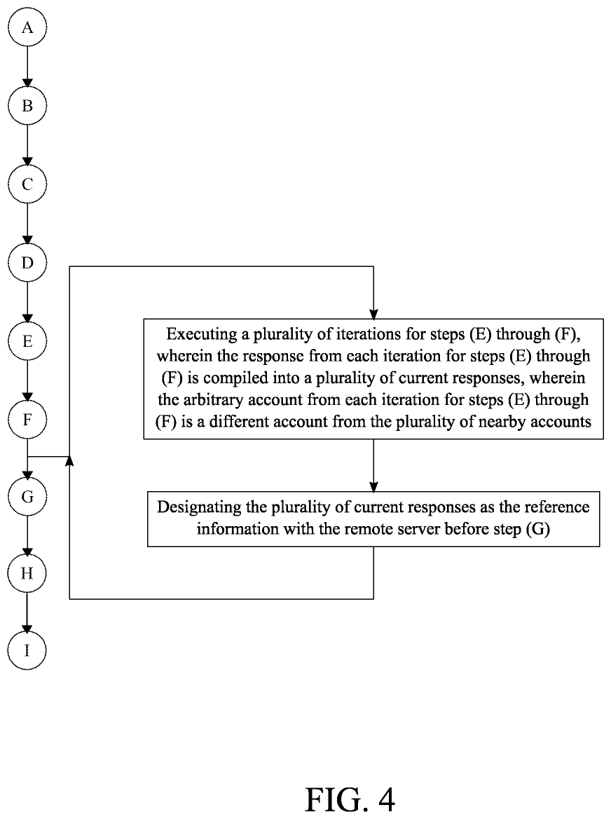

In order for the remote server to utilize a plurality of responses from multiple nearby accounts as the reference information and with reference to FIG. 4, the following subprocess is executed. A plurality of iterations for Steps E through F is executed. The response from each iteration for Steps E through F is complied into a plurality of current responses. Moreover, the arbitrary account from each iteration for Steps E through F is a different account from the plurality of nearby accounts. In more detail, the remote server collects multiple real-time response from multiple nearby accounts and compiles each response into the plurality of current responses. Then, the remote server designates the plurality of current responses as the reference information before Step G. Thus, the remote server can utilize multiple real-time responses from multiple nearby accounts as the reference information.

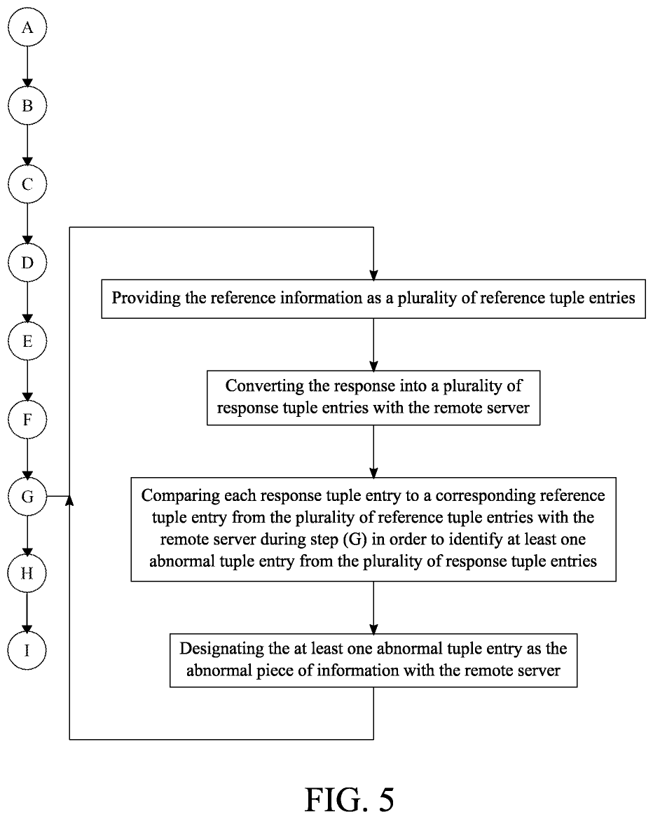

In order for the remote server to receive and analyze the response in a tuple form and with reference to FIG. 5, the following subprocess is executed. The reference information is provided as a plurality of reference tuple entries. The plurality of reference tuple entries may be provided in multiple forms such as, but not limited to, quad-tuples for food orders or six-tuples for resolving an incident. The remote server converts the response into a plurality of response tuple entries with the remote server. For example, a quad-tuple entry may be the following: [participating-responder, order-object, order-object-characteristic, object-characteristic, characteristic-value] and a six-tuple entry may be the following: [participating-responder, event-location, event-time, event-object, object-characteristic, characteristic-value]. The remote server then compares each response tuple entry to a corresponding reference tuple entry from the plurality of reference tuple entries during Step G in order to identify at least one abnormal tuple entry from the plurality of response tuple entries. In more detail, the remote server can easily analyze each response in the form of tuples by comparing each element of the response tuples to the elements of the reference tuples. The abnormal tuple entry can either be a missing element or a contradictory element in the response tuple. Finally, the remote server designates the at least one abnormal tuple entry as the abnormal piece of information with the remote server. Thus, the remote server can receive and analyze the response in a tuple form.

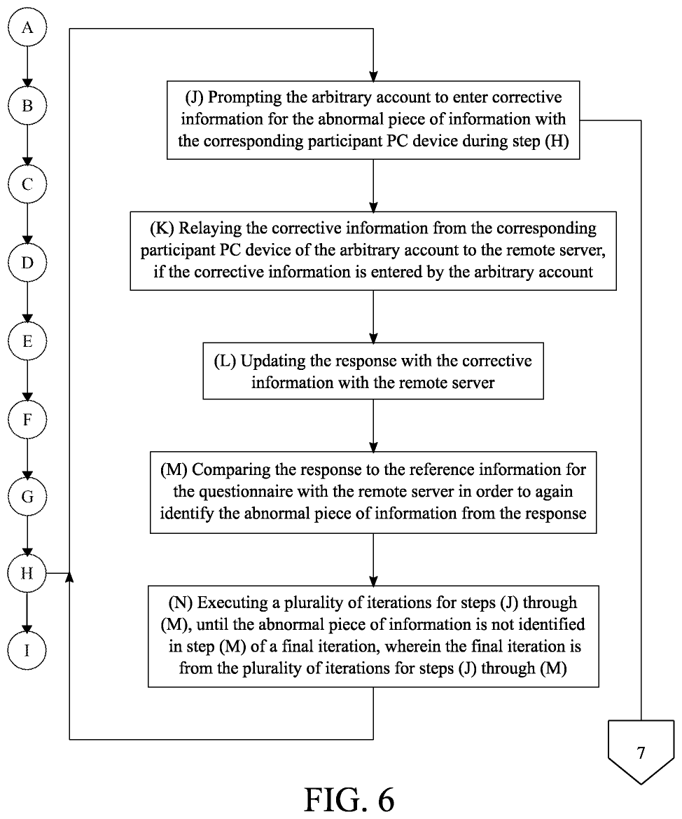

With reference to FIG. 6, the following subprocess details the interrogation process. First, the corresponding participant PC device prompts the arbitrary account to enter corrective information for the abnormal piece of information during Step H (Step J). The corrective information may be information that fills any missing information within the response and/or eliminates contradictions within the response. The corrective information is relayed from the corresponding participant PC device of the arbitrary account to the remote server, if the corrective information is entered by the arbitrary account (Step K). The remote server updates the response with the corrective information (Step L). In more detail, the response is adjusted with the corrective information in order to attempt to fill any missing information and/or eliminate contradictions within the response. The remote server then compares the response to the reference information for the questionnaire in order to again identify the abnormal piece of information from the response (Step M). In more detail, the remote server checks to see if the missing information and/or contradictions within the response have been resolved by the corrective information. A plurality of iterations is executed for Steps J through M, until the abnormal piece of information is not identified in Step M of a final iteration (Step N). The final iteration is from the plurality of iterations for Steps J through M. In more detail, the remote server will continuously interact with the user of the arbitrary account until the missing information and/or contradictions are resolved within the response.

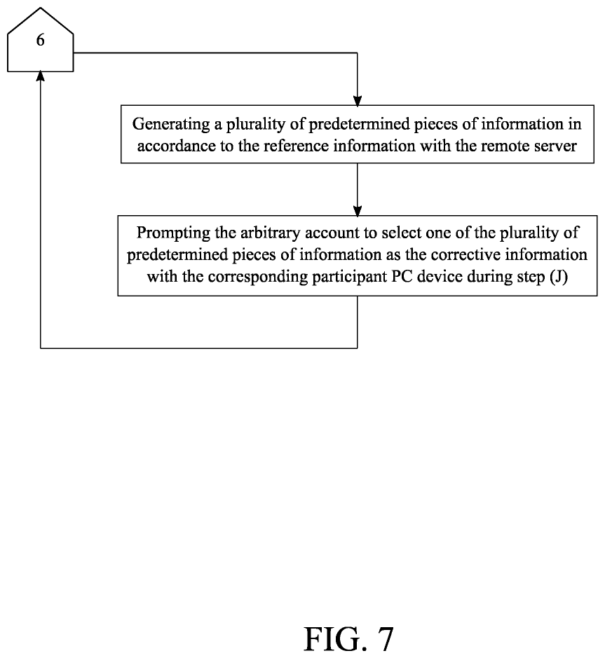

In order for the remote server to provide options for the corrective information to the arbitrary account and with reference to FIG. 7, the following subprocess is executed. The remote server generates a plurality of predetermined pieces of information in accordance to the reference information. The plurality of predetermined pieces of information is a set of information that is predicted to fill missing information within the response and/or eliminate contradictions within the response. For example, if one user associated with the arbitrary account originally entered that a vehicle in an event was blue in a response, but other users associated to other arbitrary accounts entered the vehicle in an event was green, then the predetermined piece of information may be that the vehicle is green. The corresponding participant PC device then prompts the arbitrary account to select one of the plurality of predetermined pieces of information as the corrective information during Step J. Thus, the user can change his or her entry by selecting an option provided by the remote server in order to fill missing information and/or eliminate contradictions within the response.

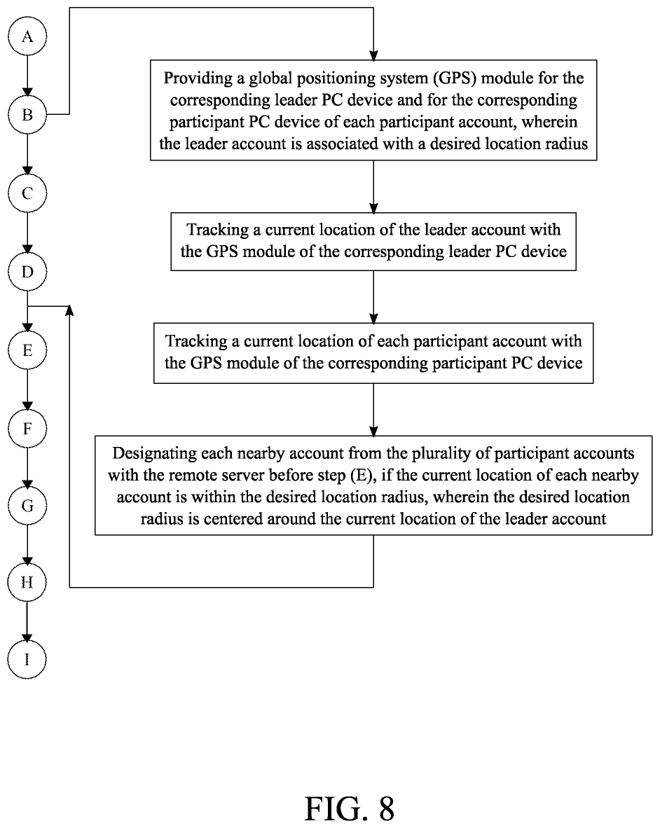

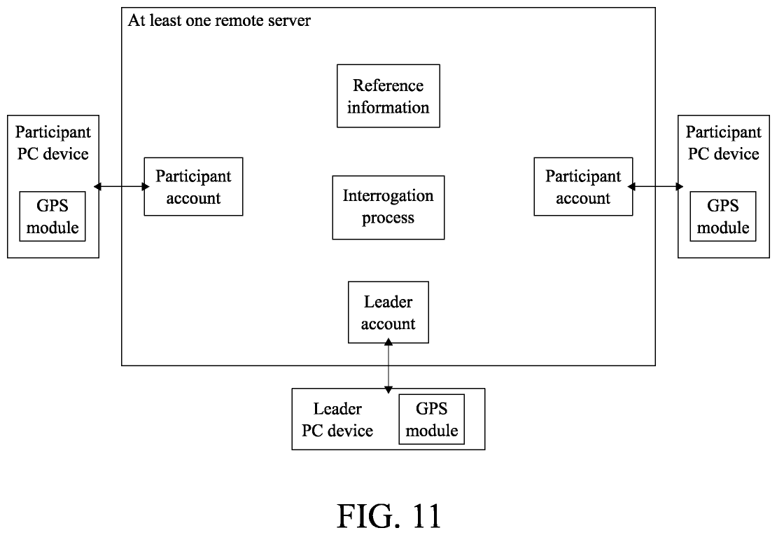

In order for the plurality of nearby accounts to be geofenced around the leader account and with reference to FIGS. 8 and 11, the following subprocess is executed. A global positioning system (GPS) module is provided for the corresponding leader PC device and the corresponding participant PC device of each participant account. The leader account is associated with a desired location radius. The GPS module is a device able to communicate with location detection satellites in order to receive geographical coordinates. The desired location radius is a radius that can be entered by the leader account in order to limit how close do nearby accounts need to be in order to participate in the questionnaire. The GPS module of the corresponding leader PC device tracks a current location for the leader account. The current location of the leader account is the real-time geospatial positioning of the corresponding leader PC device belonging to the user associated with the leader account. Similarly, the GPS module of the corresponding participant PC device tracks a current location of each participant account. The current location of each participant account is the real-time geospatial positioning of the corresponding participant PC device belonging to users associated to a participant account. The remote server designates each nearby account from the plurality of participant accounts before Step E, if the current location of each nearby account is within the desired location radius. The desired location radius is centered around the current location of the leader account. Thus, the plurality of nearby accounts is geofenced around the leader account.

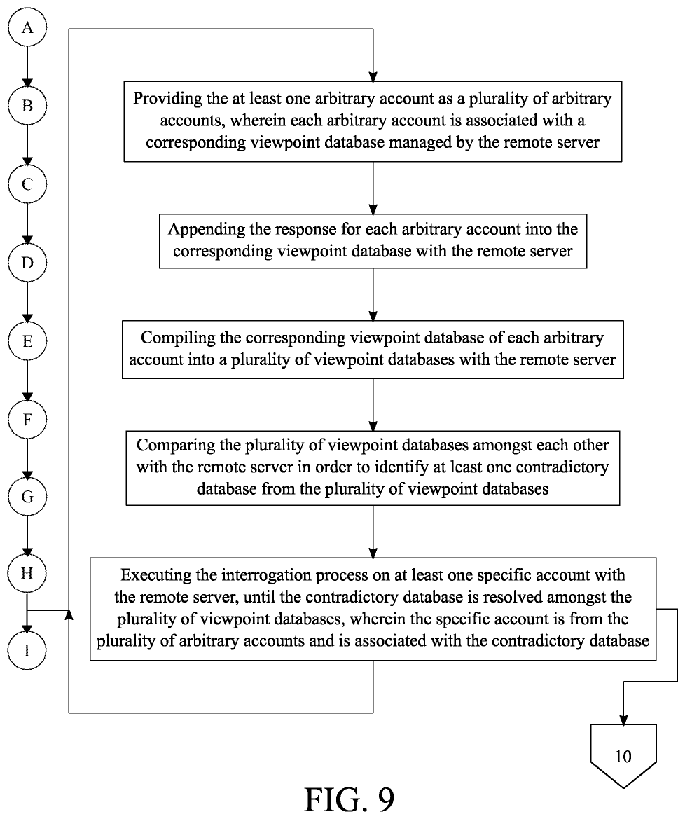

With reference to FIG. 9, the following subprocess generates a database for each user associated to an arbitrary account and merges the databases in order to eliminate contradictions. The at least one arbitrary account is provided as a plurality of arbitrary accounts. Each arbitrary account is associated with a corresponding viewpoint database managed by the remote server. In more detail, the remote server generates a viewpoint database for each arbitrary account in order to separate and organize information provided by each arbitrary account. The remote server appends the response for each arbitrary account into the corresponding viewpoint database. In more detail, the remote server stores all information provided by each arbitrary account into their viewpoint database. The remote server then compiles the corresponding viewpoint database of each arbitrary account into a plurality of viewpoint databases. This allows the remote server to analyze all the information provided by the arbitrary accounts by comparing the plurality of viewpoint databases amongst each other in order to identify at least one contradictory database form the plurality of viewpoint databases. The contradictory database may be a viewpoint database that is missing information and/or contains contradictions in comparison to the other viewpoint databases. The remote server executes the interrogation process on at least one specific account, until the contradictory database is resolved amongst the plurality of viewpoint databases. The specific account is from the plurality of arbitrary accounts and is associated with the contradictory database. Thus, the remote server interacts with the user associated with the specific account in order to fill any missing information and/or eliminate contradictions within the contradictory database.

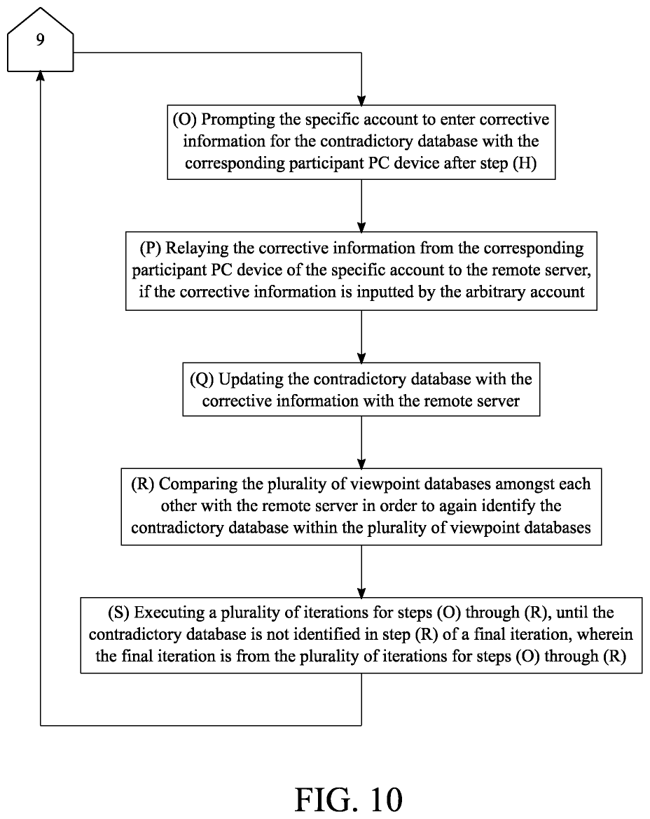

With reference to FIG. 10, the following subprocess details the interrogation process for the specific account associated with the contradictory database. First, the corresponding participant PC device prompts the specific account to enter corrective information for the contradictory database after Step H (Step O). The corrective information may be any information that can potentially fill any missing information and/or eliminate contradictions within the contradictory database. The corrective information is relayed from the corresponding participant PC device of the specific account to the remote server (Step P). Thus, the remote server has access to the corrective information. The remote server updates the contradictory database with the corrective information (Step Q). In more detail, the remote server either adds and/or adjusts information within the contradictory database by using the corrective information. The remote server then compares the plurality of viewpoint databases amongst each other with the remote server in order to again identify the contradictory database within the plurality of viewpoint databases (Step R). In more detail, the remote server checks to see if the contradictory database is resolved by the corrective information. A plurality of iterations for Steps O through R is executed, until the contradictory database is not identified in Step R of a final iteration. The final iteration is from the plurality of iterations for Steps O through R. In more detail, the remote server will continuously interact with the user of the specific account until the missing information and/or contradictions are resolved within the contradictory database.

Although the invention has been explained in relation to its preferred embodiment, it is to be understood that many other possible modifications and variations can be made without departing from the spirit and scope of the invention as hereinafter claimed.

What is claimed is:

1. A method for small cohort data collection, missing information detection, contradictions resolution, and trusted information extraction, the method comprises the steps of:
(A) providing at least one leader account managed by at least one remote server, wherein the leader account is associated with a corresponding leader personal computing (PC) device;
(B) providing a plurality of participant accounts managed by the remote server, wherein each participant account is associated with a corresponding participant PC device, wherein a plurality of nearby accounts from the plurality of participants accounts is geofenced around the leader account;
(C) prompting the leader account to enter at least one questionnaire with the corresponding leader PC device;
(D) relaying the questionnaire from the corresponding leader PC device to the remote server, if the questionnaire is entered by the leader account during step (C);
(E) prompting each nearby account to enter at least one response for the questionnaire with the corresponding participant PC device;
(F) relaying the response from the corresponding participant PC device of at least one arbitrary account to the remote server, if the response is entered by the arbitrary account during step (E), wherein the arbitrary account is any account from the plurality of nearby accounts;
(G) comparing the response to reference information for the questionnaire with the remote server in order to identify at least one abnormal piece of information from the response;
(H) executing an interrogation process on the arbitrary account with the remote server, until the abnormal piece of information is resolved within the response; and
(I) displaying the response with the corresponding leader PC device.

2. The method for small cohort data collection, missing information detection, contradictions resolution, and trusted information extraction, the method as claimed in claim 1 comprises the steps of:
providing a plurality of potential responses stored on the remote server; and
designating the plurality of potential responses as the reference information with the remote server before step (G).

3. The method for small cohort data collection, missing information detection, contradictions resolution, and trusted information extraction, the method as claimed in claim 1 comprises the steps of:
executing a plurality of iterations for steps (E) through (F), wherein the response from each iteration for steps (E) through (F) is compiled into a plurality of current responses, wherein the arbitrary account from each iteration for steps (E) through (F) is a different account from the plurality of nearby accounts; and
designating the plurality of current responses as the reference information with the remote server before step (G).

4. The method for small cohort data collection, missing information detection, contradictions resolution, and trusted information extraction, the method as claimed in claim 1 comprises the steps of:
providing the reference information as a plurality of reference tuple entries;
converting the response into a plurality of response tuple entries with the remote server;
comparing each response tuple entry to a corresponding reference tuple entry from the plurality of reference tuple entries with the remote server during step (G) in order to identify at least one abnormal tuple entry from the plurality of response tuple entries; and
designating the at least one abnormal tuple entry as the abnormal piece of information with the remote server.

5. The method for small cohort data collection, missing information detection, contradictions resolution, and trusted information extraction, the method as claimed in claim 1 comprises the steps of:
(J) prompting the arbitrary account to enter corrective information for the abnormal piece of information with the corresponding participant PC device during step (H);
(K) relaying the corrective information from the corresponding participant PC device of the arbitrary account to the remote server, if the corrective information is entered by the arbitrary account;
(L) updating the response with the corrective information with the remote server;
(M) comparing the response to the reference information for the questionnaire with the remote server in order to again identify the abnormal piece of information from the response; and
(N) executing a plurality of iterations for steps (J) through (M), until the abnormal piece of information is not identified in step (M) of a final iteration, wherein the final iteration is from the plurality of iterations for steps (J) through (M).

6. The method for small cohort data collection, missing information detection, contradictions resolution, and trusted information extraction, the method as claimed in claim 5 comprises the steps of:
generating a plurality of predetermined pieces of information in accordance to the reference information with the remote server; and
prompting the arbitrary account to select one of the plurality of predetermined pieces of information as the corrective information with the corresponding participant PC device during step (J).

7. The method for small cohort data collection, missing information detection, contradictions resolution, and trusted information extraction, the method as claimed in claim 1 comprises the steps of:
providing a global positioning system (GPS) module for the corresponding leader PC device and for the corresponding participant PC device of each participant account, wherein the leader account is associated with a desired location radius;
tracking a current location of the leader account with the GPS module of the corresponding leader PC device;
tracking a current location of each participant account with the GPS module of the corresponding participant PC device; and
designating each nearby account from the plurality of participant accounts with the remote server before step (E), if the current location of each nearby account is within the desired location radius, wherein the desired location radius is centered around the current location of the leader account.

8. The method for small cohort data collection, missing information detection, contradictions resolution, and trusted information extraction, the method as claimed in claim 1 comprises the steps of:
providing the at least one arbitrary account as a plurality of arbitrary accounts, wherein each arbitrary account is associated with a corresponding viewpoint database managed by the remote server;
appending the response for each arbitrary account into the corresponding viewpoint database with the remote server;
compiling the corresponding viewpoint database of each arbitrary account into a plurality of viewpoint databases with the remote server;
comparing the plurality of viewpoint databases amongst each other with the remote server in order to identify at least one contradictory database from the plurality of viewpoint databases; and
executing the interrogation process on at least one specific account with the remote server, until the contradictory database is resolved amongst the plurality of viewpoint databases, wherein the specific account is from the plurality of arbitrary accounts and is associated with the contradictory database.

9. The method for small cohort data collection, missing information detection, contradictions resolution, and trusted information extraction, the method as claimed in claim 8 comprises the steps of:
(O) prompting the specific account to enter corrective information for the contradictory database with the corresponding participant PC device after step (H);
(P) relaying the corrective information from the corresponding participant PC device of the specific account to the remote server, if the corrective information is inputted by the arbitrary account;
(Q) updating the contradictory database with the corrective information with the remote server;
(R) comparing the plurality of viewpoint databases amongst each other with the remote server in order to again identify the contradictory database within the plurality of viewpoint databases; and
(S) executing a plurality of iterations for steps (O) through (R), until the contradictory database is not identified in step (R) of a final iteration, wherein the final iteration is from the plurality of iterations for steps (O) through (R).
